(19) United States
(12) Patent Application Publication
(10) Pub. No.: US 2010/0200391 A1
(43) Pub. Date: Aug. 12, 2010

(54) Method for Lowering the Sublimation Point of a Small-Molecular Organic Semiconducting Material

(75) Inventors: Tu Lee, Sindian City (TW); Shih-Chia Chang, Pingjhen City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: NATIONAL CENTRAL UNIVERSITY, Jhongli City (TW)

(21) Appl. No.: 12/503,320

(22) Filed: Jul. 15, 2009

(30) Foreign Application Priority Data
Feb. 11, 2009 (TW) 98104331

(51) Int. Cl. B01J 19/10

(52) U.S. Cl. 204/157.62; 204/157.15; 204/158.14

(57) ABSTRACT

Disclosed herein is a method of lowering the sublimation point of a small-molecular organic semiconducting material. The method comprises the steps of forming a suspension solution of the small-molecular organic semiconducting material in a polar solvent, and sonicating the suspension solution with an ultrasound wave under low temperature.

### RELATED APPLICATIONS

This application claims priority to Taiwan Application Serial Number 98104331, filed Feb. 11, 2009, which is herein incorporated by reference.

### BACKGROUND

1. Field of Invention

The present invention in general relates to a method for lowering the sublimation point of a small-molecular organic semiconducting material.

2. Description of Related Art

Nowadays, conductive organic materials are commonly applied to various devices such as rechargeable battery, photovoltaic cell, sensor, microwave adsorbing material, and semiconductor device. Conductive organic materials are conductive polymers having properties such as low density, good manufacturing ability, anti-corrosion, and the ability to form large area film. Therefore, they are potential candidates for replacing metal or inorganic conductive materials in the future.

Conductive organic materials are generally classified into three types in accordance with their conductivity, which are organic semiconductor, organic polymer metal, and organic superconductor. For the organic semiconductor, there are small-molecular organic semiconductor, polymer, and organic metal complex material wherein the small-molecular organic semiconductor can be divided into two groups, which is n-type and p-type semiconductor. Among the p-type small-molecular organic semiconductors, pentacene (2,3,6,7-dibenzoanthracene) has good performance in manufacturing effective device.

Two methods are generally adopted in industry for forming a layer of conductive organic material on a device. One method is to dissolve the solid small-molecular organic semiconducting material in a solvent, coating the solution on the device, and drying the solvent to form a layer of thin film. However, small-molecular organic semiconducting material is difficult to dissolve in common solvent, and specific solvent is needed for dissolving, which not only increases the cost of the products, but also increases risks in damaging the environment. Another method is to sublimate the small-molecular organic semiconducting material by physic vapor deposition (PVD) to form a layer of thin film on device. However, the device is easily damaged due to the high processing temperature.

Therefore, there exist in this art a need of an improved method of lowering the sublimation point of a small-molecular organic semiconducting material.

### SUMMARY

According to one embodiment of the present invention, a method of lowering the sublimation point of a small-molecular organic semiconducting material is provided. A suspension solution of a small-molecular organic semiconducting material is formed by suspending the small-molecular organic semiconducting material in a polar solvent. The small-molecular organic semiconducting material has a molecular weight of lower than 5,000. In one example, the small-molecular organic semiconducting material is pentacene (or 2,3,6,7-dibenzoanthracene). In another example, the small-molecular organic semiconducting material is Alq3 (tris(8-hydroxyquinoline)aluminum (III)). The suspension solution is sonicated with an ultrasound wave at a temperature below 0° C. In one example, the polar solvent is water, dichloromethane, or xylene. The sublimation point of the small-molecular organic semiconducting material such as pentacene and Alq3 can be lowered to 210 and 180° C. respectively.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a schematic graph of an apparatus useful in the present invention;

FIG. 2 is a flow chart diagram illustrating a method for lowering the sublimation point of a small-molecular organic semiconducting material according to the embodiment of present invention;

FIG. 3 illustrates the sublimation point of pentacene measured by hot stage optical microscopy (HSOM), in which each curve represents the sublimation point change for samples A1 (curve (a)), A2 (curve (b)), B1 (curve (c)), B2 (curve (d)) and B3 (curve (e));

FIG. 4 is the graph of a Fourier transform infrared absorption (FT-IR) spectrum of pentacene, in which each curve represents the signal intensity for samples A1 (curve (a)), A2 (curve (b)), B1 (curve (c)), B2 (curve (d)) and B3 (curve (e));

FIG. 5 is the graph of powder X-ray diffraction spectrum (PXRD) of pentacene, in which each curve represents the signal intensity for samples A1 (curve (a)), A2 (curve (b)), B1 (curve (c)), B2 (curve (d)) and B3 (curve (e));

FIG. 6 is the graph of thermo gravimetric analysis (TGA) of Alq3, in which each curve represents the sublimation point change for samples C1 (curve (a)), C2 (curve (b)), D1 (curve (c)), D2 (curve (d)) and D3 (curve (e));

FIG. 7 is the graph of Fourier transform infrared absorption (FT-IR) spectrum of Alq3, in which each curve represents the signal intensity for samples C1 (curve (a)), C2 (curve (b)), D1 (curve (c)), D2 (curve (d)) and D3 (curve (e)); and

FIG. 8 is the graphs of powder X-ray diffraction spectrum (PXRD) of Alq3, in which each curve represents the signal intensity for samples C1 (curve (a)), C2 (curve (b)), D1 (curve (c)), D2 (curve (d)) and D3 (curve (e)).

### DETAILED DESCRIPTION

In view of the afore-mentioned drawback in the existing art, embodiments of the present invention provide a method for lowering the sublimation point of a small-molecular semiconducting material by use of ultrasound, which provides a non-invasive way of improving crystal properties and process controllability.

### Overview in Sonochemistry

Sonochemistry or the chemical processes of ultrasound has found may uses in several areas including medicine, biology, marine biology, aviation, food, chemical engineering and etc. Recently, the sonochemistry is applied to almost every branch of chemistry, including biochemistry, organic chemistry, polymer chemistry, analytical chemistry, inorganic chemistry, electrochemistry, photochemistry, stereochemistry, and environmental chemistry.

Ultrasound, with an acoustic wavelength much longer than the size of a molecule and ranges between 0.015-10 cm (e.g. 15 kHz-10 MHz) in liquid, may increase the rate of a chemical reaction and thereby facilitating the production of new products. In operation, ultrasound wave will not directly interact with the molecule but asserts its action through a serious of physical and chemical reaction termed “cavitation.” Cavitation is a phenomenon occurs when a high intensity ultrasound wave passes through a liquid, the micro bubbles in the liquid expand quickly and then collapse adiabatically. At the moment of collapsing, the micro bubbles form “hot spot”, where the instantaneous temperature is above 5,000K and the pressure is above 2,000 atm. The “hot spot” cools down thereafter at a rate about 109 K/s and generates impact wave and jet flow with speed above 400 km/hr in the liquid. Environmental factors may affect the intensity of cavitation, and directly change the reaction rate and products yield. The environmental factors include temperature, hydrostatic pressure, as well as the frequency, power, intensity of the ultrasonic wave. In addition, the species and quantity of dissolved gases, solvent, sample pre-treatment, and buffer solution may also affect the intensity of cavitation.

### Lowering the Sublimation Point of a Small-Molecular Semiconducting Material by use of Ultrasound

In one aspect of this invention, a method for lowering the sublimation point of a small-molecular semiconducting material is provided. The method includes steps of: forming a suspension solution of the small-molecular semiconducting material in a polar solvent; and sonicating the suspension solution with an ultrasound wave under low temperature.

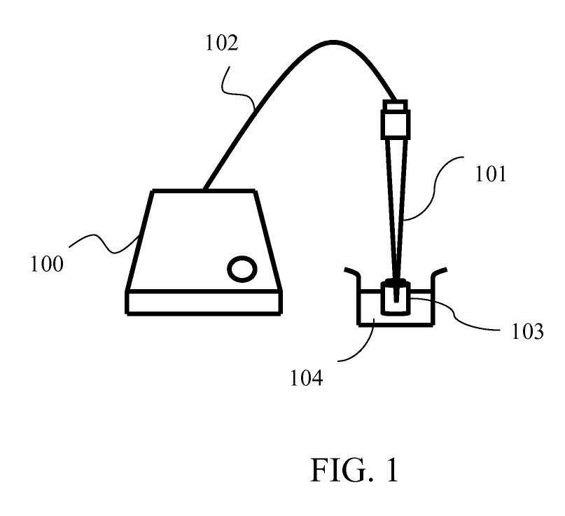

FIG. 1 is a schematic graph of an apparatus useful in the present invention. The sonicator 100 (Misonix Inc, New York, USA) may generate an ultrasound wave with a frequency ranging from 10 to 20 kHz at a voltage ranging from 1000 to 1500 V. The sonicator 100 is coupled to a sonicator probe 101 through a cable 102. The sonicator has a length of 20-22 cm and a tip with a diameter of 0.1-0.5 cm.

The sonicator probe 101 placed in the vial 103 is distanced from the bottom of the vial 103 for about 0.5 cm. The vial 103 is immersed in a coolant 104 to control the temperature of the suspension solution. The level of the coolant 104 is over the level of the suspension solution in the vial 103.

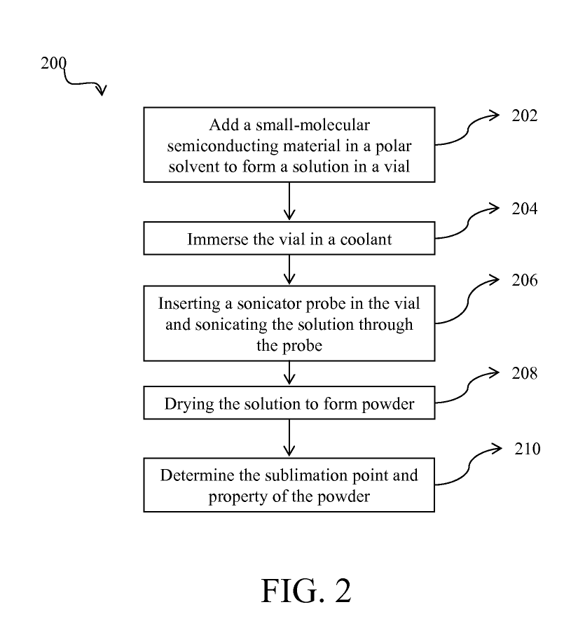

FIG. 2 is a flow diagram of a method 200 for lowering the sublimation point of a small-molecular semiconducting material according to one embodiment of the invention. The method starts at step 202 by adding a small-molecular semiconducting material in a polar solvent to form a suspension solution in a vial. In one example, the polar solvent is selected from a group consisting of water, dichlorobenzene and xylene. In one example, the vial is a scintillation vial and has a volume about 10 ml. In one example, the small-molecular organic semiconducting material has a molecular weight lower than 5,000. The suitable small-molecular organic semiconductor material is pentacene(2,3,6,7-dibenzoanthracene) or Alq3 (tris(8-hydroxyquinoline aluminum (III)).

Pentacene (2,3,6,7-dibenzoanthracene) (C₂₂H₁₄, M.W.=278.35) (Sigma-Aldrich Steinheim, Germany), has the following structure:

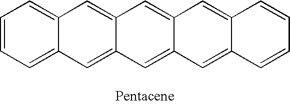

Alq3 (tris(8-hydroxyquionline)aluminum (III)) (C₂₇H₁₈AlN₃O₃, MW: 459.44, α form), which is commercially available from Sigma-Aldrich (Steinheim, Germany), has the following structure:

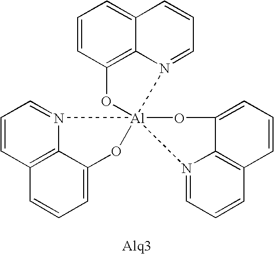

In step 204, the vial containing the small-molecular organic semiconducting material is immersed in a coolant. The coolant is used to provide a temperature below 0° C. In one example, the coolant has a temperature about −13° C. Suitable coolant that may be used in this invention includes, but is not limited to, ethylene glycol.

In step 206, the solution in the vial is sonicated by inserting a sonicator probe into the vial. In one example, the sonicator was operated at a voltage about 1500 V, and a frequency about 10 kHz to about 20 kHz. The sonication is performed for about 5 to 10 minutes. In one example, the operation frequency of the sonicator is about 20 kHz and the operation time is about 10 minutes.

In step 208, the solution sonicated under low temperature as described above is dried to form powder-like crystals. The solution is poured into an evaporation pan and dried at a temperature of about 40° C. in vacuum for about 3 to 4 hours. In one example, the evaporation pan has a diameter about 12 cm. In one example, the drying time is about 12 hours. The power-like crystals thus formed are then collected for further analysis as described in step 210.

In step 210, the power-like crystals collected in previous step are subjected to analysis including determination of the sublimation point and other properties of the powder such as crystal morphology. Hot stage optical microscopy (HSOM) and thermo gravimetric analyzer (TGA) were used to measure sublimation point of the crystals. In addition, Fourier transform infrared spectroscopy (FT-IR) and powder X-ray diffraction (PXRD) (comparing with the single X-ray data bank) are utilized to confirm whether the lowereing of the sublimation point is due to degradation of the small-molecular organic semiconducting material or to the structure change in the crystal lattice.

### EXAMPLES

The following Examples are provided to illustrate certain aspects of the present invention and to aid those of skilled in the art in practicing this invention. These Examples are in no way to be considered to limit the scope of the invention in any manner.

### Example 1

### Lowereing the Sublimation Point of Pentacene

Two solvents were used to respectively dissolve pentacene and formed respective suspension solutions. Pentacene (20 mg) was dissolved in either pure water or dichlorobenzene (about 4 ml each) in a 10 ml vial and formed a suspension solution. Then, the vial was immersed in a coolant which contained ethylene glycol and the temperature was controlled at about −13° C. A sonicating probe was placed inside the vial and the suspension solution was sonicated for about 10 minutes at an operational voltage of 1500 V and a frequency about 20 kHz. Then, the suspension solution was dried at 40° C. on an evaporation pan in vacuum for 12 hours. Then, the powder was collected and proceeded with measurements including hot stage optical microscopy (HSOM), Fourier transform infrared absorption spectrum (FT-IR) and X-ray diffraction spectrum (PXRD).

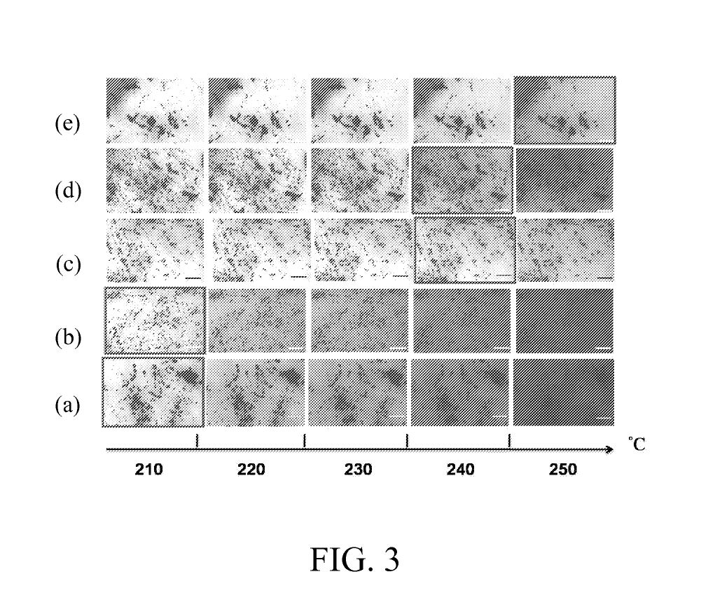

Three comparative pentacene samples were also prepared, these samples were processed by at least one treatment(s) listed in Table I, which includes, but is not limited to, (1) grinding, so as to further decrease the grain diameter of pentacene; (2) sonicating the suspension at room temperature; or (3) without any treatment at all. Results were illustrated in FIGS. 3 to 5.

TABLE 1

| Sample | | | Low temperature | |
|---|---|---|---|---|
| No. | Sonicating | Solvent | (<0° C.) | Grinding |
| A1 | | Pure water | | — |
| A2 | | Dichlorobenzene | | — |
| B1 | — | — | — | |
| B2 | | Dichlorobenzene | — | — |
| B3 | — | — | — | — |

(symbol represents steps that were performed)

FIG. 3 depicted the variation of sublimation point of pentacene measured by hot stage optical microscopy (HSOM). The principle for determining a change in sublimation point by HSOM is that during sublimation, the sublimated material would adhere onto the objective lens of the microscopy and thereby affecting the light transmittance. Therefore, the sublimation point is defined as the temperature when the view under the microscope suddenly becomes dark. Accordingly, the sublimation point measured for samples A1, A2, B1, B2 and B3 are (a) 210° C., (b) 210° C., (c) 240° C., (d) 240° C., and (e) 250° C., respectively.

The sublimation point of sample B3 (i.e., raw material of pentacene) was about 250° C., which was same as the reference. The sublimation point of samples A1 and A2 were about 210° C., respectively, which was about 40° C. lower than the sublimation point of the raw material. As to the respective sublimation point of samples B1 and B2, it was respectively at about 240° C. These results indicated that the sublimation point of pentacene was hardly affected by either grinding or sonicating at room temperature. In contrast, sonicaing pentacene at low temperature may lower the sublimation point of pentacene.

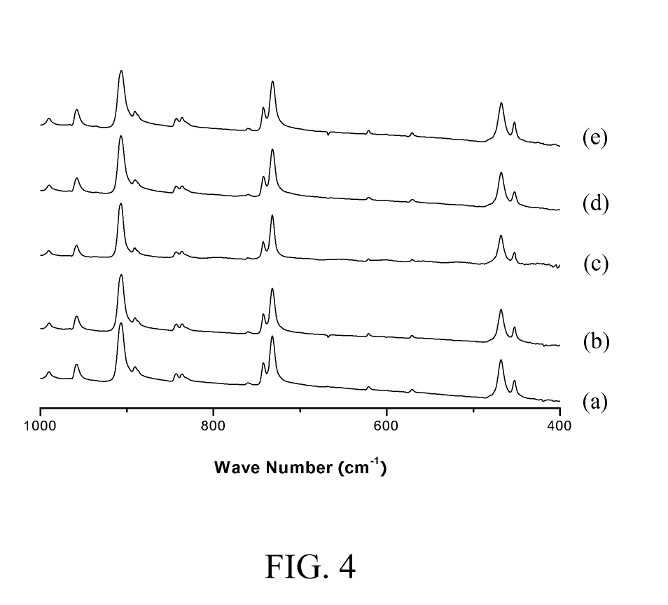

FIG. 4 is the graph of Fourier transform infrared absorption (FT-IR) spectrum of pentacene. There were hardly any changes in the FT-IR spectrums for samples A1, A2, B1, B2 and B3. Accordingly, pentacene was not degraded, nor was there any new matters formed by sonicating treatment, which confirmed that the change in the pentacene sublimation point was not due to degradation.

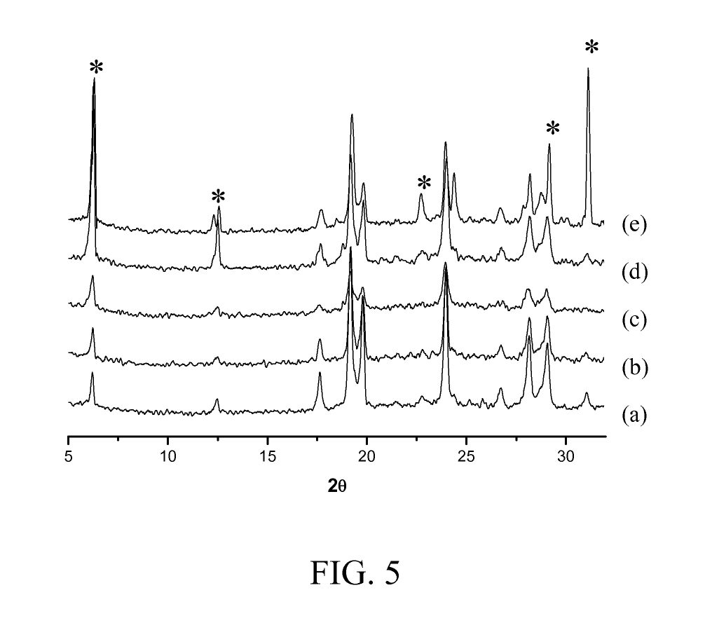

FIG. 5 is the X-ray diffraction spectrum (PXRD) of pentacene powder. It is clear from FIG. 5, signal intensity for pentacene sonicated at low temperature, was weak at points 2 0=6.3°, 12.6°, 22.7°, 29.0° and 31.0°. It is believed that pentacene would re-crystallize after sonicating at low temperature, and the disordered pentacene molecules would result in weaker π-π stacking interaction force between the molecules and thereby lowering the energy requirement to sublimate pentacene, hence a lower sublimation point of pentacene is reached.

### Example 2

### Lowering the Sublimation Point of Alq3

Two solvents were used to respectively dissolve Alq3 and form respective suspension solutions. Alq3 (20 mg) was dissolved in either pure water or xylene (about 4 ml each) in a 10 ml vial and formed a suspension solution. Then, the vial was immersed in a coolant which contained ethylene glycol and the temperature were controlled at about −13° C. A sonicating probe was placed inside the vial and the suspension solution was sonicated for about 10 minutes at an operational voltage of 1500 V and a frequency about 20 kHz. Then, the suspension solution was dried at 40° C. on an evaporation pan in vacuum for 12 hours. Then, the powder was collected and analyzed by thermo gravimetric analysis (TGA), FT-IR, and PXRD.

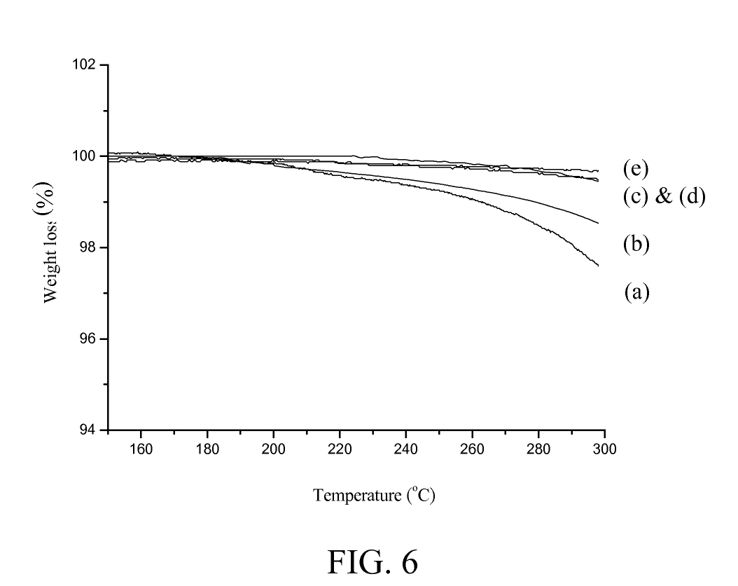

Three comparative Alq3 examples were also prepared, these samples were processed by at least one treatment(s) listed in Table 2, which includes, but is not limited to, (1) grinding, so as to further decrease the grain diameter of Alq3; (2) sonicating the suspension at room temperature; or (3) without any treatment at all. Results were illustrated in FIGS. 6 to 8.

TABLE 2

| Sample | | | | |
|---|---|---|---|---|
| No. | Sonicating | Solvent | Low temperature (<0° C.) | Grinding |
| C1 | | Pure water | | — |
| C2 | | Xylene | | — |
| D1 | — | — | — | |
| D2 | | Xylene | — | — |
| D3 | — | — | — | — |

(symbol represents steps that were performed)

FIG. 6 depicted the variation of sublimation point of Alq3 measured by thermo gravimetric analysis (TGA). The principle for determining the change in sublimation point by TGA is that during sublimation, the weight of sublimated material would loss. Therefore, the sublimation point is defined as the temperature when the weight of sublimated material begin to loss. Accordingly, the sublimation point measured for samples C1, C2, D1, D2 and D3 are (a) 200° C., (b) 180° C., (c) 250° C., (d) 250° C., and (e) 300° C., respectively.

The weight losing ratio for samples C1 and C2 at 300° C. were 2.5% and 1.5%, respectively. On the other hand, the respective weight losing ratio for samples D1, D2, and D3 were below 1% at 300° C. These results indicated that the sublimation point of Alq3 was hardly affected by either grinding or sonicating at room temperature. In contrast, sonicaing Alq3 at low temperature may lower the sublimation point of Alq3.

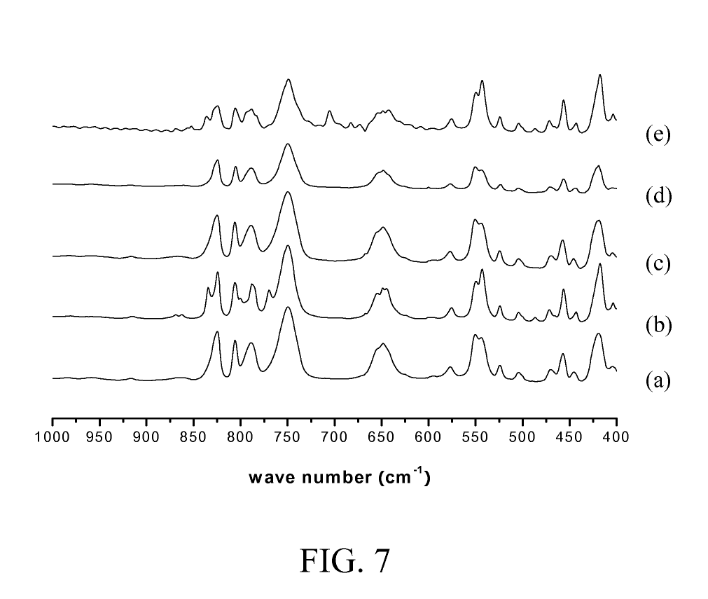

FIG. 7 is the graph of Fourier transform infrared absorption (FT-IR) spectrum of Alq3. There were hardly any changes in the FT-IR spectrums for samples C1, C2, D1, D2 and D3. Accordingly, Alq3 was not degraded, nor was there any new matter formed by sonicating treatment, which confirmed that the change in the Alq3 sublimation point was not due to degradation.

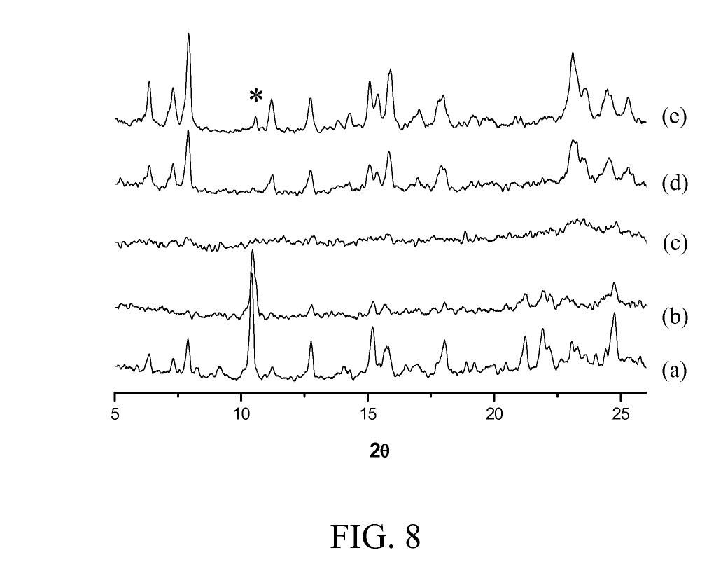

FIG. 8 is the X-ray diffraction spectrum (PXRD) of Alq3 powder. It is clear from FIG. 8, signal for Alq3 sonicated at low temperature appears at points where 2 θ=9°-11°, such result indicates the existence of high-energy lattice ε-Alq3. It is believed the relatively unstable high-energy lattice may sublimate under lower temperature thereby resulting in a lower sublimation point of the small-molecule semiconductor Alq3

Although the present invention has been described in considerable detail with reference certain embodiments thereof, other embodiments are possible. Therefore, their spirit and scope of the appended claims should no be limited to the description of the embodiments container herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method of lowering the sublimation point of a small-molecular organic semiconducting material, comprising:
forming a suspension solution of the small-molecular organic semiconducting material in a solvent, wherein the small-molecular organic semiconducting material has a molecular weight of lower than 5,000; and
sonicating the suspension solution with an ultrasound wave at a temperature below 0° C. for about 10 minutes.

2. The method of claim 1, wherein the small-molecular organic semiconducting material is 2,3,6,7-dibenzoanthracene or tris(8-hydroxyquinoline)aluminum (III).

3. The method of claim 1, wherein the ultrasound wave has an operational voltage of about 1500 V and a frequency ranges from about 10 MHz to about 20 MHz

4. The method of claim 1, wherein the solvent is water, dichlorobenzene or xylene.

5. The method of claim 4, wherein the solvent is water.

6. The method of claim 1, wherein the temperature is about −13° C.

7. The method of claim 1, wherein the sublimation point of small-molecular organic semiconducting material is lowered for about 200° C.

8. The method of claim 2, wherein the sublimation point of 2,3,6,7-dibenzoanthracene is lowered for about 30-50° C.

9. The method of claim 2, wherein the sublimation point of 2,3,6,7-dibenzoanthracene is lowered to about 210° C.

10. The method of claim 2, wherein the sublimation point of tris(8-hydroxyquinoline)aluminum (III) is lowered for about 90-120° C.

11. method of claim 2, wherein the sublimation point of tris(8-hydroxyquinoline)aluminum (III) is lowered to about 180-200° C.
